(19) United States
(12) Patent Application Publication
(10) Pub. No.: US 2026/0117014 A1
(43) Pub. Date: Apr. 30, 2026

(54) RESIN COMPOSITION FOR FORMING PHASE-SEPARATED STRUCTURE, METHOD FOR PRODUCING STRUCTURE INCLUDING PHASE-SEPARATED STRUCTURE, AND BLOCK COPOLYMER

(71) Applicant: TOKYO OHKA KOGYO CO., LTD., Kawasaki-shi (JP)

(72) Inventors: Junichi Tsuchiya, Kawasaki-shi (JP); Ken Miyagi, Kawasaki-shi (JP); Shota Iino, Kawasaki-shi (JP)

(21) Appl. No.: 19/362,035

(22) Filed: Oct. 17, 2025

(30) Foreign Application Priority Data
Oct. 25, 2024 (JP) 2024-187931

(51) Int. Cl. C08F 287/00; C08F 2/48

(52) U.S. Cl. CPC C08F 287/00; C08F 2/48

(57) ABSTRACT

A resin composition including a block copolymer having a first block, a second block, and a third block, in which the third block is located between the first block and the second block The first block includes a polymer having a repeating structure of a structural unit represented by the following formula (b1), the second block including a polymer having a repeating structure of structural unit represented by the following formula (b2), the third block includes a polymer having a repeating structure of structural unit derived from a high Log P monomer, and the high Log P monomer has a higher Log P value than methyl methacrylate

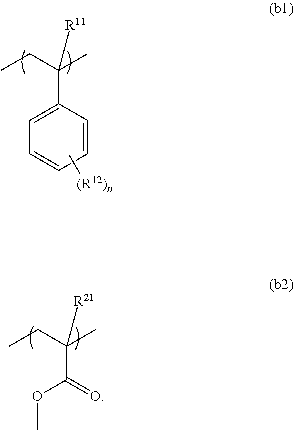

This application claims priority to Japanese Patent Application No. 2024-187931, filed Oct. 25, 2024, the entire content of which is incorporated herein by reference.

### BACKGROUND OF THE INVENTION

### Field of the Invention

The present invention relates to a resin composition for forming a phase-separated structure, a method for producing a structure having a phase-separated structure, and a block copolymer.

### Related Art

In recent years, following further miniaturization of a large-scale integrated circuit (LSI), a technique for processing a finer structure has been demanded. In response to such a demand, a technique has been developed to form a finer structure by utilizing a phase-separated structure formed by self-assembly of block copolymers in which mutually incompatible blocks are bonded to each other (refer, for example, to Patent Document 1).

The block copolymers separate (phase-separate) into micro-regions due to repulsion between the mutually incompatible blocks, then are subjected to heat treatment or the like to form a structure having a regular periodic structure. The periodic structure may be a cylinder (columnar), lamella (plate-like), sphere (spherical), or the like.

To use this phase-separated structure of block copolymers, it is essential that self-assembled nanostructures formed by micro-phase separation be formed only in specific regions and be arranged in a desired direction. To control a position and an orientation of these nanostructures, processes such as graphoepitaxy, which controls phase separation patterns by guiding patterns, and chemical epitaxy, which controls phase separation patterns by differences in a chemical state of a substrate, have been proposed (see, for example, Non-Patent Document 1).

The block copolymer forms a structure having a regular periodic structure by phase separation. The phrase “structural period” means a period of a phase structure observed when a structure having a phase-separated structure is formed and refers to a sum of lengths of phases incompatible with each other. In a case where a phase-separated structure forms a cylinder structure perpendicular to a surface of a substrate, a structural period (L₀) is a distance between centers (pitch) of two adjacent cylinder structures.

It is known that the structural period (L₀) is determined by inherent polymerization properties such as a degree of polymerization N or the Flory-Huggins interaction parameter χ. That is, the larger the product of χ and N “χ·N”, the greater the mutual repulsion between different blocks in the block copolymer. Therefore, in the case of χ·N>10.5 (hereinafter, referred to as “intensity separation limit”), repulsion between different types of blocks in the block copolymer is large, leading to a stronger tendency to cause phase separation. Accordingly, at the intensity separation limit, the structural period is approximately N^{2/3}·χ^{1/6} and a relationship expressed in the following formula (1) is satisfied. That is, the structural period is proportional to the degree of polymerization N, which correlates with a molecular weight and a molecular weight ratio between different blocks.

$${L}_{0} ∝ a \cdot {N}^{2 / 3} \cdot {X}^{1 / 6} \qquad ( 1 )$$

[wherein L₀ denotes a structural period,
a is a parameter indicating a size of a monomer,
N denotes a degree of polymerization, and
χ is an interaction parameter, in which a higher value means a higher phase separation performance.]

Accordingly, the structural period (L₀) can be controlled by adjusting a composition and a total molecular weight of the block copolymer. Therefore, to form a structure having a relatively large L₀ by utilizing a phase-separated structure formed by self-assembly of block copolymers, a method for increasing a molecular weight of the block copolymers is considered.
Patent Document 1: Japanese Unexamined Patent Application, Publication No. 2008-36491
Non-Patent Document 1: Proc. SPIE 7637, Alternative Lithographic Technologies II, 76370G (Apr. 1, 2010)

### SUMMARY OF THE INVENTION

However, when the molecular weight of the block copolymer is simply increased, the phase separation rate decreases, and as a result, when it is desired to orient the block copolymer in either the vertical direction or the horizontal direction with respect to the surface of the substrate, there may be a problem that both are mixed.

In addition, in order to form a finer pattern using a phase-separated structure formed by self-assembly of block copolymers, it is required to have excellent in-plane uniformity of pattern dimensions.

The present invention has been made in view of the above circumstances, and an object of the present invention is to provide a resin composition for forming a phase-separated structure capable of forming a phase-separated structure excellent in orientation and in-plane uniformity, a method for producing a structure including a phase-separated structure using the resin composition, and a block copolymer for use in the resin composition for forming a phase-separated structure.

In order to solve the above problems, the present inventors have conducted intensive studies, and as a result, have found that the above problems can be solved by using a predetermined block copolymer, and have completed the present invention. Specifically, the present invention provides the following.

A first aspect is a resin composition for forming a phase-separated structure containing a block copolymer having a first block, a second block, and a third block,
in which the third block is located between the first block and the second block,
the first block is composed of a polymer having a repeating structure of structural unit represented by the following formula (b1),
the second block is composed of a polymer having a repeating structure of structural unit represented by the following formula (b2),
the third block is composed of a polymer having a repeating structure of structural unit derived from a high Log P monomer, and
the high Log P monomer has a higher Log P value than methyl methacrylate:

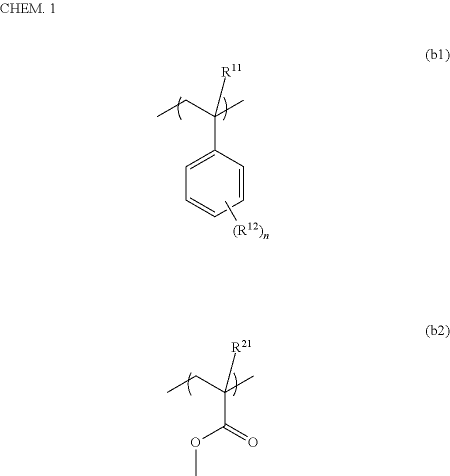

in formula (b1), R¹¹ represents a hydrogen atom or a methyl group,
R¹² represents a substituent having 1 to 5 carbon atoms, and
n is an integer of 0 or more and 5 or less, and
in formula (b2), R²¹ represents a hydrogen atom or a methyl group.

A second aspect is a method for producing a structure having a phase-separated structure, including applying the resin composition for forming a phase-separated structure of the first aspect onto a support to form a layer containing a block copolymer, and phase-separating the layer containing the block copolymer.
A third aspect is a block copolymer including a first block, a second block, and a third block,
in which the third block is located between the first block and the second block,
the first block is composed of a polymer having a repeating structure of structural unit represented by the following formula (b1),
the second block is composed of a polymer having a repeating structure of structural unit represented by the following formula (b2),
the third block is composed of a polymer having a repeating structure of structural unit derived from a monomer, and
the monomer has a higher Log P value than methyl methacrylate:

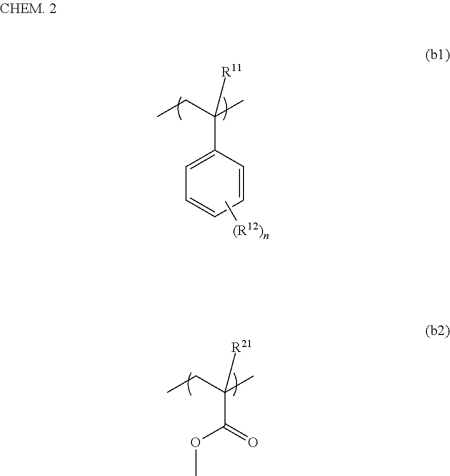

in formula (b1), R¹¹ represents a hydrogen atom or a methyl group,
R¹² represents a substituent having 1 to 5 carbon atoms, and
n is an integer of 0 or more and 5 or less, and in formula (b2),
R²¹ represents a hydrogen atom or a methyl group.

According to the present invention, it is possible to provide a resin composition for forming a phase-separated structure capable of forming a phase-separated structure excellent in orientation and in-plane uniformity, a method for producing a structure including a phase-separated structure using the resin composition, and a block copolymer to be used in the resin composition for forming a phase-separated structure.

### BRIEF DESCRIPTION OF THE DRAWINGS

FIG. 1 is a schematic process diagram illustrating one embodiment of a method for producing a structure including a phase-separated structure;

FIG. 2 is a drawing illustrating one embodiment of an optional process;

FIG. 3 is a drawing showing examples corresponding to evaluation criteria of vertical orientation in an Example; and

FIG. 4 is a drawing showing examples corresponding to evaluation criteria of horizontal orientation in an Example.

### DETAILED DESCRIPTION OF THE INVENTION

Hereinafter, embodiments of the present invention will be described in detail, but the present invention is not limited to the following embodiments at all, and can be carried out with appropriate modifications within the scope of the object of the present invention.

### Resin Composition for Forming Phase Separated-Structure

The resin composition for forming a phase-separated structure contains a block copolymer having a first block, a second block, and a third block. The third block is located between the first block and the second block. The first block is composed of a polymer having a repeating structure of structural unit represented by the following formula (b1). The second block is composed of a polymer having a repeating structure of structural unit represented by the following formula (b2). The third block is composed of a polymer having a repeating structure of structural unit derived from a high Log P monomer. The high Log P monomer has a higher Log P value than methyl methacrylate.

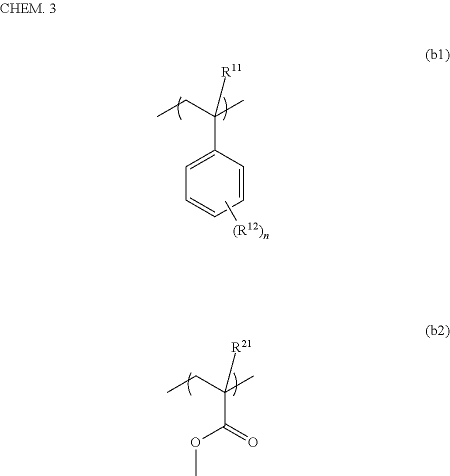

In formula (b1), R¹¹ represents a hydrogen atom or a methyl group,
R¹² represents a substituent having 1 to 5 carbon atoms, and
n is an integer of 0 or more and 5 or less, and in formula (b2),
R²¹ represents a hydrogen atom or a methyl group.

In order to improve the orientation, the present inventors have studied replacing the block composed of a structural unit derived from methyl methacrylate or the like with a block in which a structural unit derived from methyl methacrylate or the like and a structural unit that lowers an interaction parameter (χ) of the block copolymer are randomly arranged. A phase separation rate is generally said to decrease as the interaction parameter increases. Therefore, by using a block copolymer having a small interaction parameter, the phase separation rate is improved, and as a result, the orientation is considered to improve. However, when such a block copolymer is used, a phase-separated structure having excellent orientation can be formed, but there is room for improvement in in-plane non-uniformity.

In contrast, the resin composition for forming a phase-separated structure of the first aspect can form a phase-separated structure excellent in orientation and in-plane uniformity. The reason why such an effect is obtained is inferred as follows.

When a layer containing a block copolymer is phase-separated and then a phase composed of blocks in which multiple types of structural units are randomly arranged is selectively removed, since solubilities of the blocks are not uniform, a part of the phase cannot be completely removed, which lowers the in-plane uniformity. On the other hand, in the resin composition for forming a phase-separated structure of the first aspect, since a block composed of the structural unit derived from a high Log P monomer and lowering the interaction parameter (χ) of the block copolymer is disposed between the block composed of the structural unit derived from styrene or the like and the block composed of the structural unit derived from methyl methacrylate or the like, the solubilities of the blocks are uniform. This makes it possible to form a phase-separated structure excellent in-plane uniformity, in addition to excellent orientation.

### Block Copolymer

### First Block

A first block is composed of a polymer having a repeating structure of structural unit (hereinafter, also referred to as a structural unit (b1)) represented by the following formula (b1):

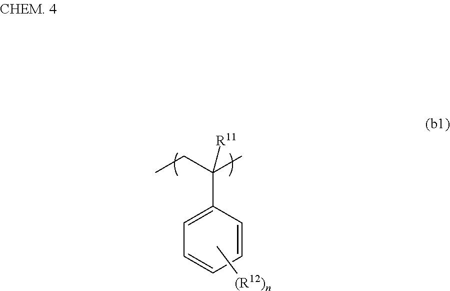

in which, in formula (b1), R¹¹ represents a hydrogen atom or a methyl group,
R¹² represents a substituent having 1 to 5 carbon atoms and
n is an integer of 0 or more and 5 or less.

The number of carbon atoms of the substituent as R¹² is preferably 1 or more and 3 or less. Examples of the substituent as R¹² include an optionally substituted hydrocarbon group, an optionally substituted alkoxy group, an optionally substituted alkylsilyl group, and an optionally substituted alkylsilyloxy group. Among these, an optionally substituted hydrocarbon group is preferable.

Examples of the optionally substituted hydrocarbon group as R¹² include an optionally substituted alkyl group and an optionally substituted cycloalkyl group. Among these, an optionally substituted alkyl group is preferable.

Examples of the alkyl group as R¹² include a methyl group, an ethyl group, an n-propyl group, an isopropyl group, an n-butyl group, a sec-butyl group, an isobutyl group, and a tert-butyl group.

Examples of the cycloalkyl group as R¹² include a cyclobutyl group and a cyclopentyl group.

Examples of the alkoxy group as R¹² include a methoxy group, an ethoxy group, an n-propoxy group, an isopropoxy group, an n-butoxy group, a sec-butoxy group, an isobutoxy group, and a tert-butoxy group.

Examples of the alkylsilyl group as R¹² include a trialkylsilyl group such as a trimethylsilyl group.

Examples of the alkylsilyloxy group as R¹² include a trialkylsilyloxy group such as a trimethylsilyloxy group.

Examples of the substituent that the hydrocarbon group, the alkoxy group, the alkylsilyl group, and the alkylsilyloxy group as R¹² may have include an alkoxy group, an alkylsilyl group, an alkylsilyloxy group, and a halogen atom.

n is preferably an integer of 0 or more and 3 or less, more preferably 0 or 1, and still more preferably 0.

### Second Block

The second block is composed of a polymer having a repeating structure of structural unit (hereinafter, also referred to as a structural unit (b2).) represented by the following formula (b2):

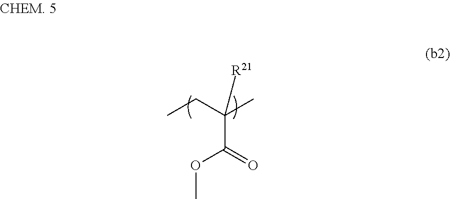

in which, in formula (b2), R²¹ represents a hydrogen atom or a methyl group.

### Third Block

A third block is composed of a polymer having a repeating structure of structural unit derived from a high Log P monomer. The high Log P monomer has a higher Log P value than methyl methacrylate (1.207). Note that the “Log P value” means a logarithmic value of octanol/water partition coefficient (Pow), and in the present specification, the Log P value of a monomer is a value calculated using calculation software manufactured by Advanced Chemistry Development (ACD/Labs).

The Log P value of the high Log P monomer is preferably 1.21 or more, more preferably 1.21 or more and 4 or less, still more preferably 1.25 or more and 4 or less, particularly preferably 1.3 or more and 4 or less, and most preferably 1.35 or more and 3.5 or less. Within the above numerical range, desired effects can be easily obtained.

The structural unit derived from the high Log P monomer may be structural unit (b1) or structural unit (b2), but is preferably neither structural unit (b1) nor structural unit (b2).

The structural unit derived from the high Log P monomer is preferably a structural unit (hereinafter, also referred to as a “structural unit (b3)”) represented by the following formula (b3):

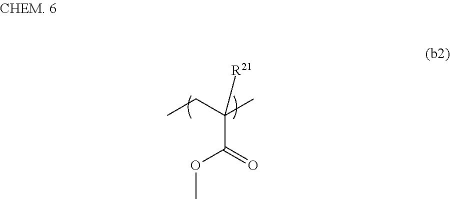

in which, in formula (b3), R³¹ represents a hydrogen atom or a methyl group,
L represents a single bond or a divalent linking group and
R³² represents an organic group having 1 to 15 carbon atoms.

Examples of the divalent linking group as L include a divalent linking group containing a heteroatom such as an oxygen atom, a nitrogen atom, or a sulfur atom.

Examples of the divalent linking group containing a heteroatom include groups represented by —O—, —C(═O)—O—, —C(═O)—, —O—C(═O)—O—, —C(═O)—NR—, —NR—, —NR—C(═NR)—, —S—, —S(═O)₂—, and —S(═O)₂—O—, in which each R is independently a hydrogen atom or a substituent (for example, an alkyl group or an acyl group). Note that in the present specification, the bonding direction of the divalent groups is not particularly limited unless otherwise specified.

The number of carbon atoms of the alkyl group and the acyl group as R is preferably 1 or more and 10 or less, and more preferably 1 or more and 5 or less.

L is a group represented by —C(═O)—O—, and the carbonyl group in —C(═O)—O—, is preferably bonded to the carbon atom to which R³¹ is bonded.

The number of carbon atoms of the organic group as R³² is preferably 1 or more and 10 or less, and more preferably 2 or more and 8 or less. Examples of the organic group as R³² include acyclic hydrocarbon group, an alicyclic hydrocarbon group, an aromatic hydrocarbon group, a heterocyclic group, and combinations thereof.

R³² is preferably an optionally substituted alkyl group having 2 or more and 15 or less carbon atoms, or a group represented by —R³³—R³⁴. Here, R³³ represents a single bond or a methylene group, and R³⁴ represents an optionally substituted cycloalkyl group, an optionally substituted aromatic hydrocarbon group, or an optionally substituted heterocyclic group.

The number of carbon atoms of the alkyl group as R³² is preferably 2 or more and 10 or less, and more preferably 2 or more and 8 or less. The alkyl group may be linear or branched. Examples of the alkyl group include an ethyl group, an n-propyl group, an isopropyl group, an n-butyl group, an isobutyl group, a sec-butyl group, a tert-butyl group, an n-pentyl group, an n-hexyl group, an n-heptyl group, and an n-octyl group.

Examples of the substituent which the alkyl group as R³² may have include a halogen atom, an alkenyl group, a silicon atom-containing group, an alicyclic hydrocarbon group, and an aromatic hydrocarbon group.

Examples of the halogen atom as the substituent include a fluorine atom, a chlorine atom, a bromine atom and an iodine atom. The number of carbon atoms of the alkenyl group as the substituent is preferably 2 or more and 10 or less. The alkenyl group may be linear or branched. Examples of the alkenyl group include a vinyl group and a propenyl group. Examples of the silicon atom-containing group as the substituent include silyl groups such as a trimethylsilyl group, a triethylsilyl group, a t-butyldimethylsilyl group, and a triphenylsilyl group.

The alicyclic hydrocarbon group as the substituent may be a monocyclic group or a polycyclic group. As the monocyclic alicyclic hydrocarbon group, a group in which one hydrogen atom is removed from a monocycloalkane is preferable. The number of carbon atoms of the monocycloalkane is preferably 3 or more and 6 or less. Examples of the monocycloalkane include cyclopentane and cyclohexane. As the polycyclic alicyclic hydrocarbon group, a group in which one hydrogen atom is removed from a polycycloalkane is preferable. The number of carbon atoms of the polycycloalkane is preferably 7 or more and 12 or less. Examples of the polycycloalkane include polycycloalkanes having a polycyclic skeleton of a bridged ring system, such as adamantane, norbornane, and isobornane.

The aromatic hydrocarbon group as the substituent may be a monocyclic aromatic group, a group formed by fusion of two or more aromatic hydrocarbon groups, or a group formed by bonding two or more aromatic hydrocarbon groups via a single bond. Examples of the aromatic hydrocarbon group include a phenyl group, a naphthyl group, and a biphenyl group. The number of carbon atoms of the aromatic hydrocarbon group is preferably 6 or more and 12 or less, and more preferably 6 or more and 10 or less.

The number of carbon atoms of the cycloalkyl group as R³⁴ is preferably 3 or more and 10 or less, and more preferably 4 or more and 8 or less. Examples of the cycloalkyl group as R³⁴ include a cyclobutyl group, a cyclopentyl group, a cyclohexyl group, a cycloheptyl group, and a cyclooctyl group.

The aromatic hydrocarbon group as R³⁴ may be a monocyclic aromatic group, a group formed by fusion of two or more aromatic hydrocarbon groups, or a group formed by two or more aromatic hydrocarbon groups bonding via a single bond. Examples of the aromatic hydrocarbon group include a phenyl group, a naphthyl group, and a biphenyl group. The number of carbon atoms of the aromatic hydrocarbon group as R³⁴ is preferably 6 or more and 15 or less, and more preferably 6 or more and 10 or less.

The heterocyclic group as R³⁴ may be an aliphatic heterocyclic group or an aromatic heterocyclic group, and an aliphatic heterocyclic group is preferable. The number of carbon atoms of the heterocyclic group as R³⁴ is preferably 3 or more and 10 or less, and more preferably 3 or more and 6 or less. The heteroatom contained in the heterocyclic group as R³⁴ is preferably an oxygen atom. Examples of the aliphatic heterocyclic ring constituting the aliphatic heterocyclic group include a tetrahydrofuran ring, a pyrrolidine ring, a tetrahydrothiophene ring, a tetrahydropyran ring, a piperidine ring, and a thiane ring.

Examples of the substituent that the cycloalkyl group, the aromatic hydrocarbon group, and the heterocyclic group as R³⁴ may have include a halogen atom, an alkyl group, an alkenyl group, a halogenated alkyl group, a silicon atom-containing group, an alicyclic hydrocarbon group, and an aromatic hydrocarbon group. Preferable embodiments of the halogen atom, the alkenyl group, the silicon atom-containing group, the alicyclic hydrocarbon group, and the aromatic hydrocarbon group are the same as those of the substituent which the alkyl group as R³² may have.

The number of carbon atoms of the alkyl group as the substituent is preferably 1 or more and 10 or less. The alkyl group may be linear or branched.

Examples of the halogenated alkyl group as the substituent include groups in which some or all of the hydrogen atoms within the alkyl group as the substituent are substituted with halogen atoms. As the halogenated alkyl group, a fluorinated alkyl group is preferable, and a perfluoroalkyl group is particularly preferable.

A ratio of the number of moles of the structural unit of the first block to the sum of the number of moles of the structural unit of the first block, the number of moles of the structural unit of the second block, and the number of moles of the structural unit of the third block is preferably 10 mol % or more and 80 mol % or less. The proportion of the number of moles of the structural unit of the first block is more preferably 20 mol % or more, still more preferably 30 mol % or more, particularly preferably 40 mol % or more, and most preferably 50 mol % or more. The proportion of the number of moles of the structural unit of the first block is more preferably 75 mol % or less, and still more preferably 70 mol % or less.

A ratio of the number of moles of the structural unit of the second block to the sum of the number of moles of the structural unit of the first block, the number of moles of the structural unit of the second block, and the number of moles of the structural unit of the third block is preferably 10 mol % or more and 80 mol % or less. The proportion of the number of moles of the structural unit of the second block is more preferably 15 mol % or more, still more preferably 20 mol % or more, and particularly preferably 25 mol % or more. The proportion of the number of moles of the structural unit of the second block is more preferably 70 mol % or less, still more preferably 60 mol % or less, particularly preferably 50 mol % or less, and most preferably 45 mol % or less.

A ratio of the number of moles of the structural unit of the third block to the sum of the number of moles of the structural unit of the first block, the number of moles of the structural unit of the second block, and the number of moles of the structural unit of the third block is preferably 0.1 mol % or more and 20 mol % or less from the viewpoint of easily obtaining the desired effects. The proportion of the number of moles of the structural unit of the third block is more preferably 0.5 mol % or more, and still more preferably 1 mol % or more. In addition, the proportion of the number of moles of the structural unit of the third block is more preferably 15 mol % or less, still more preferably 10 mol % or less, and particularly preferably 5 mol % or less, from the viewpoint that excellent orientation and in-plane uniformity tend to be obtained.

The block copolymer may have other blocks in addition to the first block, the second block, and the third block. In a preferred embodiment, the block copolymer is a triblock copolymer composed of the first block, the second block, and the third block.

A number average molecular weight (Mn) of the block copolymer is preferably 50,000 or more and 500,000 or less, more preferably 100,000 or more and 300,000 or less, still more preferably 100,000 or more and 200,000 or less, and particularly preferably 120,000 or more and 180,000 or less, from the viewpoint of easily obtaining the desired effects. Molecular weight dispersity (Mw/Mn) of each block constituting the block copolymer is preferably 1.0 or more and 1.5 or less, more preferably 1.0 or more and 1.4 or less, and still more preferably 1.0 or more and 1.3 or less. In the present specification, the “number average molecular weight” (Mn) and the “weight average molecular weight” (Mw) mean a number average molecular weight and a weight average molecular weight, respectively, in terms of standard polystyrene determined by gel permeation chromatography (GPC) measurement, unless otherwise specified. When a value of Mn or Mw is given a unit (gmol-), the value represents a molar mass.

The structural period (L₀) including a phase-separated structure prepared using a block copolymer is not particularly limited, but may be, for example, 30 nm or more, 40 nm or more, or 50 nm or more. The period may be 100 nm or less, 90 nm or less, 80 nm or less, 70 nm or less, or 60 nm or less.

### Homopolymers

The resin composition for forming a phase-separated structure preferably includes a homopolymer. Thus, the desired effects are easily obtained particularly in the resin composition for forming a phase-separated structure exhibiting a phase-separated structure of a cylinder.

The homopolymer is preferably at least one polymer selected from the group consisting of a polymer (I) composed of the repeating structure of structural unit represented by formula (b1) and a polymer (II) composed of the repeating structure of structural unit represented by formula (b2). The structural units of the polymer (I) and the polymer (II) may be the same as or different from the structural units of the block copolymer.

As the polymer (I), polystyrene is preferable. As the polymer (II), polymethyl methacrylate is preferable.

A number average molecular weight (Mn) of the homopolymer is preferably 500 or more and 50,000 or less, more preferably 1,000 or more and 10,000 or less, and still more preferably 1,000 or more and 5,000 or less.

The content of the homopolymer is preferably 10 parts by mass or more and 200 parts by mass or less, more preferably 20 parts by mass or more and 160 parts by mass or less, and still more preferably 30 parts by mass or more and 140 parts by mass or less with respect to 100 parts by mass of the content of the block copolymer.

A content of the polymer (I) is preferably 5 parts by mass or more and 130 parts by mass or less, more preferably 15 parts by mass or more and 120 parts by mass or less, and still more preferably 20 parts by mass or more and 110 parts by mass or less with respect to 100 parts by mass of the block copolymer. A content of the polymer (II) is preferably 5 parts by mass or more and 60 parts by mass or less, more preferably 5 parts by mass or more and 50 parts by mass or less, and still more preferably 10 parts by mass or more and 45 parts by mass or less with respect to 100 parts by mass of the block copolymer.

### Organic Solvent Components

The resin composition for forming a phase-separated structure preferably contains an organic solvent. As the organic solvent component, any organic solvent may be used as long as the solvent dissolves each component to be used and can form a uniform solution. Any organic solvent selected from organic solvents conventionally known as a solvent for a composition containing a resin as a main component can be used.

Examples of the organic solvent component include lactones such as γ-butyrolactone; ketones such as acetone, methyl ethyl ketone, cyclohexanone, methyl-n-pentyl ketone, methyl isopentyl ketone and 2-heptanone; polyhydric alcohols such as ethylene glycol, diethylene glycol, propylene glycol and dipropylene glycol; monoacetates of polyhydric alcohols such as ethylene glycol monoacetate, diethylene glycol monoacetate, propylene glycol monoacetate and dipropylene glycol monoacetate; polyhydric alcohol derivatives, such as compounds having an ether bond such as monoalkyl ethers of the polyhydric alcohols, monoalkyl ethers of monoacetates of the polyhydric alcohols, monophenyl ethers of the polyhydric alcohols, and monophenyl ethers monoacetates of the polyhydric alcohols (Examples of monoalkyl ethers include monomethyl ether, monoethyl ether, monopropyl ether, and monobutyl ether, or the like.) [among these, propylene glycol monomethyl ether acetate (PGMEA) and propylene glycol monomethyl ether (PGME) are preferred]; cyclic ethers such as dioxane; esters such as methyl lactate, ethyl lactate (EL), methyl acetate, ethyl acetate, butyl acetate, methyl pyruvate, ethyl pyruvate, methyl methoxypropionate, ethyl ethoxypropionate, and esters other than the derivatives of the foregoing polyhydric alcohols; and aromatic organic solvents such as anisole, ethylbenzyl ether, cresylmethyl ether, diphenyl ether, dibenzyl ether, phenetol, butylphenyl ether, ethylbenzene, diethylbenzene, pentylbenzene, isopropylbenzene, toluene, xylene, cymene, and mesitylene. The organic solvent component may be used alone or as a mixed solvent of two or more types. Among them, propylene glycol monomethyl ether acetate (PGMEA), propylene glycol monomethyl ether (PGME), cyclohexanone, and ethyl lactate (EL) are preferable.

The organic solvent component contained in the resin composition for forming a phase-separated structure is not particularly limited. The concentration of the organic solvent component is appropriately determined depending upon the coating film thickness so that the resin composition for forming a phase-separated structure can be applied. The organic solvent component is generally used so that the solid content concentration of the resin composition for forming a phase-separated structure is in the range of 0.2% by mass or more and 70% by mass or less, and preferably 0.2% by mass or more and 50% by mass or less.

### Other Ingredients

The resin composition for forming a phase-separated structure may contain components other than the block copolymer, the homopolymer, and the organic solvent component described above. Examples of the other components include other resins, surfactants, dissolution inhibitors, plasticizers, stabilizers, colorants, antihalation agents, dyes, sensitizers, base growth agents, and basic compounds.

### Manufacturing Method for Structure Including Phase-Separated Structure

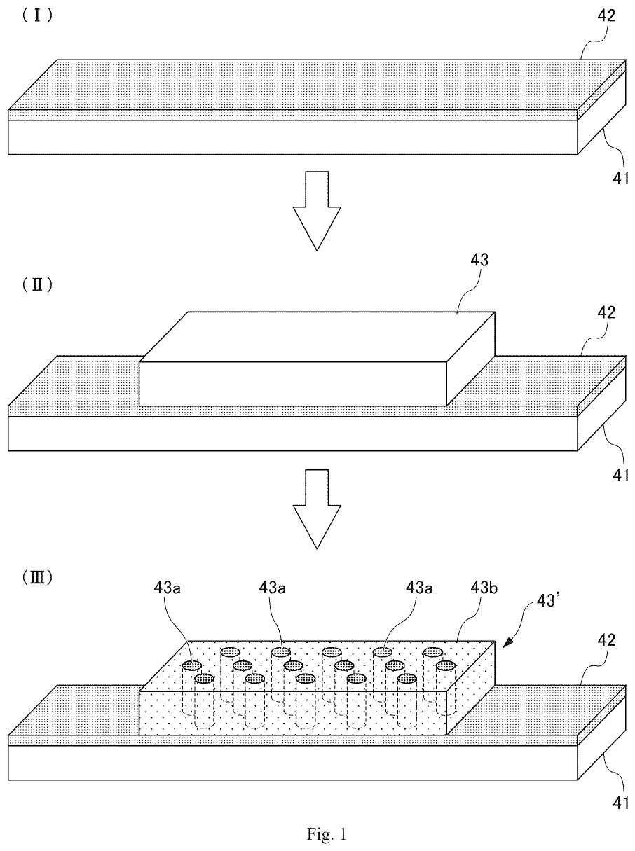

A method for producing a structure including a phase-separated structure includes applying a resin composition for forming a phase-separated structure onto a support to form a layer including a block copolymer (hereinafter, referred to as “step (i)”), and phase-separating the layer including the block copolymer (hereinafter, referred to as “step (ii)”). Hereinafter, a method for producing a structure including such a phase-separated structure will be specifically described with reference to FIG. 1. However, the method for producing a structure including the phase-separated structure is not limited to the embodiment specifically shown in FIG. 1.

FIG. 1 illustrates one example embodiment of the method for producing a structure including a phase-separated structure. In the embodiment shown in FIG. 1, first, a support 41 is coated with a primer to form a primer layer 42 (FIG. 1(I)). Next, the resin composition for forming a phase-separated structure is applied on the primer layer 42 to form a layer (BCP layer) 43 containing a block copolymer (FIG. 1(II); this concludes step (i)). Next, the BCP layer 43 is phase-separated into a phase 43a and a phase 43b by heating and annealing (FIG. 1(III); step (ii)). According to the production method of the embodiment, that is, the production method including the step (i) and the step (ii), a structure 43′ including the phase-separated structure is produced on the support 41 on which the primer layer 42 is formed.

### Step (i)

In the step (i), the resin composition for forming a phase-separated structure is applied onto the support 41 to form the BCP layer 43. In the embodiment shown in FIG. 1, first, a primer is applied on the support 41 to form the primer layer 42. By providing the primer layer 42 on the support 41, hydrophilic-hydrophobic balance between the surface of the support 41 and the layer 43 (BCP layer) containing the block copolymer can be achieved. That is, in the case where the primer layer 42 contains the resin component having the structural unit constituting the first block, adhesion between the phase composed of the first block in the BCP layer 43 and the support 41 is enhanced. In the case where the primer layer 42 contains the resin component having the structural unit constituting the second block, adhesion between the phase composed of the second block in the BCP layer 43 and the support 41 is enhanced. Therefore, when the primer layer 42 contains a resin component having both the structural unit constituting the first block and the structural unit constituting the second block, a phase-separated structure oriented in a direction perpendicular to the surface of the support 41 is easily formed by phase separation of the BCP layer 43. In addition, when the primer layer 42 contains a resin component having either one of the structural unit constituting the first block or the structural unit constituting the second block, a phase-separated structure oriented in the horizontal direction with respect to the surface of the support 41 is easily formed by phase separation of the BCP layer 43.

### Primers:

As a primer, a resin composition can be used. The resin composition for primers can be appropriately selected from conventionally known resin compositions for use in forming a thin film depending upon the type of blocks constituting the block copolymer. The resin composition for primers may be, for example, a thermally polymerizable resin composition or a photosensitive resin composition, such as a positive resist composition or a negative resist composition. In addition, a non-polymerizable film formed by using a compound as a surface treatment agent and applying the compound may be used as the primer layer. For example, a siloxane-based organic monomolecular film formed of phenethyltrichlorosilane, octadecyltrichlorosilane, hexamethyldisilazane, or the like as a surface treatment agent can also be suitably used as the primer layer.

In the case of forming a phase-separated structure oriented in the vertical direction, examples of such a resin composition include a resin composition containing a resin having both a structural unit constituting the first block and a structural unit constituting the second block, and a resin composition containing a resin having structural units all of which have high affinity with each of the blocks constituting the block copolymer. As the resin composition for primers, for example, a composition containing a resin having both styrene and methyl methacrylate as structural units, or a compound or a composition including both a site having high affinity for styrene, such as an aromatic ring, and a site having high affinity with methyl methacrylate (a functional group having high polarity or the like) is preferably used. Examples of the resin having both styrene and methyl methacrylate as structural units include random copolymers of styrene and methyl methacrylate, alternating polymers of styrene and methyl methacrylate (polymers in which each monomer is copolymerized alternately), and the like. Examples of the composition including both a site having high affinity with styrene and a site having high affinity with methyl methacrylate include a composition containing a resin obtained by polymerizing, as a monomer, a monomer having at least an aromatic ring and a monomer having a polar functional group. Examples of the monomer having an aromatic ring include monomers having an aryl group in which one hydrogen atom is removed from a ring of the aromatic hydrocarbon, such as a phenyl group, a biphenyl group, a fluorenyl group, a naphthyl group, an anthryl group, or a phenanthryl group, or monomers having a heteroaryl group in which some of carbon atoms constituting the ring of these groups is/are replaced with a heteroatom(s) such as an oxygen atom, a sulfur atom, or a nitrogen atom. Examples of the monomer having a highly polar functional group include monomers having a trimethoxysilyl group, a trichlorosilyl group, an epoxy group, a glycidyl group, a carboxy group, a hydroxy group, a cyano group, a hydroxyalkyl group in which some of the hydrogen atoms of the alkyl group is/are substituted with a hydroxy group(s), and the like. Other examples of the compound having both a site having a high affinity with styrene and a site having a high affinity with methyl methacrylate include a compound having both an aryl group and a polar functional group such as phenethyltrichlorosilane and a compound having both an alkyl group and a polar functional group such as an alkylsilane compound.

In the case of forming a phase-separated structure oriented in the horizontal direction, examples of such a resin composition include a resin composition containing a resin having any one of the structural unit constituting the first block or the structural unit constituting the second block, and a resin composition containing a resin having any one of the structural units that have high affinity with each block constituting the block copolymer.

The resin composition for primers can be produced by dissolving any one of the above-described resins in a solvent. As such a solvent, any solvent may be used as long as it dissolves each component to be used and can form a uniform solution, and examples thereof include the same solvents as those exemplified in the description of the resin compositions for forming a phase-separated structure.

The type of the support 41 is not particularly limited as long as the resin composition can be applied on the surface thereof. Examples of substrates include a substrate made of an inorganic material such as silicon, a metal (copper, chromium, iron, aluminum, or the like), glass, titanium oxide, silica, or mica; a substrate made of an oxide such as SiO₂; a substrate made of a nitride such as SiN; a substrate made of an oxynitride such as SiON; a substrate made of an organic material such as an acrylic resin, a polystyrene, a cellulose, a cellulose acetate, and a phenol resin. Among these, a silicon substrate (Si substrate) or a metal substrate is preferable, a Si substrate or a copper substrate (Cu substrate) is more preferable, and a Si substrate is particularly preferable. The size and shape of the support 41 are not particularly limited. The support 41 does not necessarily have a smooth surface, and substrates having various shapes can be appropriately selected. Examples of the substrate include a substrate having a curved surface, a flat plate having an uneven surface, and a substrate having a flaky shape.

An inorganic and/or organic film may be provided on the surface of the support 41. Examples of the inorganic film include an inorganic antireflection film (inorganic BARC). Examples of the organic film include an organic antireflection film (organic BARC). An inorganic film can be formed, for example, by applying an inorganic antireflection film composition such as a silicon-based material onto a support and baking the composition. An organic film can be formed, for example, by applying a material for forming the organic film, in which a resin component or the like to constitute the film is dissolved in an organic solvent, onto a substrate by a spinner or the like, and baking the material under heating conditions of preferably 200° C. or more and 300° C. or less and preferably 30 seconds or more and 300 seconds or less, and more preferably 60 seconds or more and 180 seconds or less. This material for forming an organic film does not necessarily require sensitivity to light or electron beams, unlike a resist film, and may or may not have sensitivity. Specifically, a resist or a resin generally used in the production of semiconductor elements or liquid crystal display elements can be used. A raw material for forming organic films is preferably a material capable of forming an organic film that can be etched, particularly dry etched, so that an organic film pattern can be formed by etching an organic film using a pattern made of a block copolymer formed by processing the BCP layer 43 and transferring the pattern to the organic film. Among them, a material that forms an organic film that is etchable by oxygen plasma is preferable. Such a material for forming an organic film may be a material conventionally used for forming an organic film such as organic BARC. Examples thereof include ARC series manufactured by Nissan Chemical Corporation, AR series manufactured by Rohm & Haas, SWK series manufactured by Tokyo Ohka Kogyo, and the like.

A method for forming the primer layer 42 by applying a primer on the support 41 is not particularly limited, and the primer layer can be formed by a conventionally known method. For example, the primer layer 42 can be formed by applying the primer onto the support 41 by a conventionally known method such as spin coating or using a spinner to form a coating film, and drying the coating film. A drying method of the coating film may be any method as long as the solvent contained in the primer can be volatilized, and examples thereof include a baking method. At this time, a baking temperature is preferably 80° C. or more and 300° C. or less, more preferably 180° C. or more and 270° C. or less, and still more preferably 220° C. or more and 250° C. or less. Baking time is preferably 30 seconds or more and 600 seconds or less, and more preferably 60 seconds or more and 600 seconds or less. A thickness of the primer layer 42 after drying the coating film is preferably about 10 nm or more and 100 nm or less, and more preferably about 40 nm or more and 90 nm or less.

Before the primer layer 42 is formed on the support 41, the surface of the support 41 may be cleaned in advance. By cleaning the surface of the support 41, coatability of the primer is improved. As a cleaning treatment method, a conventionally known method can be used, and examples thereof include an oxygen plasma treatment, an ozone oxidation treatment, an acid alkali treatment, and a chemical modification treatment.

After the primer layer 42 is formed, the primer layer 42 may be rinsed with a rinse liquid such as a solvent as necessary. Since an uncrosslinked portion, etc. in the primer layer 42 is removed by the rinsing, affinity with at least one block constituting the block copolymer is improved, and a phase-separated structure composed of a cylinder structure oriented in a direction perpendicular to the surface of the support 41 is easily formed. Note that the rinse solution may be any solution as long as it can dissolve the uncrosslinked portion, and a solvent such as propylene glycol monomethyl ether acetate (PGMEA), propylene glycol monomethyl ether (PGME), or ethyl lactate (EL), a commercially available thinner solution, or the like can be used. After the cleaning, post-baking may be performed to volatilize the rinse liquid. The temperature condition of this post-baking is preferably 80° C. or more and 300° C. or less, and more preferably 100° C. or more and 270° C. or less. The baking time is preferably 30 seconds or more and 500 seconds or less, and more preferably 60 seconds or more and 240 seconds or less. The thickness of the primer layer 42 after the post-baking is preferably about 1 nm or more and 10 nm or less, and more preferably about 2 nm or more and 7 nm or less.

Next, a layer 43 (BCP layer) including a block copolymer is formed on the primer layer 42. A method for forming the BCP layer 43 on the primer layer 42 is not particularly limited, and examples thereof include a method in which the resin composition for forming a phase-separated structure of the above-described embodiment is applied on the primer layer 42 by a conventionally known method such as spin coating or using a spinner to form a coating film, followed by drying.

A thickness of the BCP layer 43 may be any thickness as long as it is sufficient to cause phase separation, and is preferably 20 nm or more and 100 nm or less, and more preferably 20 nm or more and 80 nm or less, in consideration of the type of the support 41, the structure period size of the phase-separated structure to be formed, the uniformity of the nanostructure, or the like. For example, when the support 41 is a Si substrate, the thickness of the BCP layer 43 is preferably adjusted to 10 nm or more and 100 nm or less, and more preferably 20 nm or more and 80 nm or less.

### Step (ii)

In the step (ii), the BCP layer 43 formed on the support 41 is phase-separated. By heating and annealing the support 41 after the step (i), a phase-separated structure in which at least part of the surface of the support 41 is exposed is formed by selective removal of the block copolymer. That is, a structure 43′ including a phase-separated structure where the BCP layer has separated into the phase 43a and the phase 43b is produced on the support 41. The temperature condition of the annealing treatment is preferably equal to or higher than the glass transition temperature of the block copolymer used and lower than the thermal decomposition temperature, and for example, when the block copolymer is a polystyrene-polymethyl methacrylate (PS-PMMA) block copolymer (mass average molecular weight: 5,000 or more and 100,000 or less), the temperature is preferably 180° C. or higher and 300° C. or lower. The heating time is preferably 30 seconds or more and 3,600 seconds or less. The annealing treatment is preferably performed in a gas having low reactivity such as nitrogen.

### Optional Steps

A method for producing the structure including a phase-separated structure is not limited to the above-described embodiment, and may include a step (optional step) other than the steps (i) and (ii).

Examples of such an optional step include a step (hereinafter, referred to as “step (iii)”) of selectively removing a phase composed of at least one type of block among multiple types of blocks constituting the block copolymer in the BCP layer 43, and a guide pattern forming step.

Regarding Step (iii)

In step (iii), a phase composed of at least one type of multiple types of blocks constituting the block copolymer is selectively removed from the BCP layer formed on the primer layer 42. Thus, a fine pattern (polymer nanostructure) is formed.

Examples of a method for selectively removing the phase composed of the blocks include a method for performing oxygen plasma treatment on the BCP layer and a method for performing hydrogen plasma treatment on the BCP layer. For example, by performing oxygen plasma treatment, hydrogen plasma treatment, or the like on the BCP layer after phase separation of the BCP layer containing the block copolymer, the phase composed of the first block is not selectively removed, and the phase composed of the second block and the third block is selectively removed.

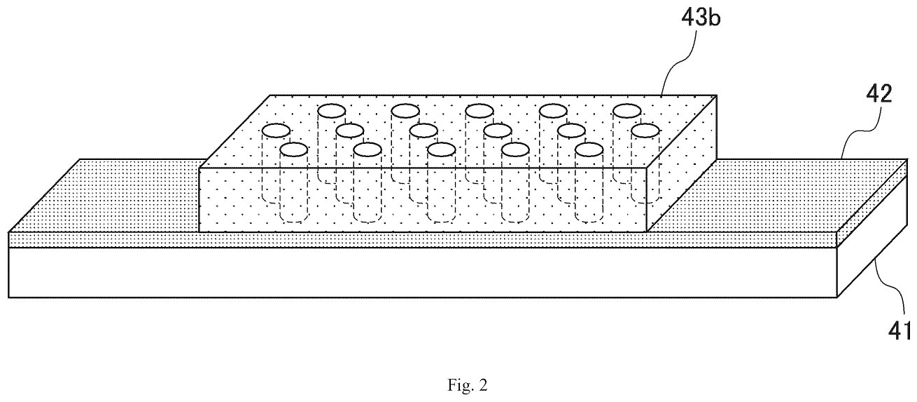

FIG. 2 illustrates one example embodiment of the step (iii). In the embodiment shown in FIG. 2, the structure 43′ produced on the support 41 in the step (ii) is subjected to oxygen plasma treatment to selectively remove the phase 43a, thereby forming a pattern (polymer nanostructure) composed of separated phases 43b. In this case, the phase 43b is a phase composed of the first block, and the phase 43a is a phase composed of the second block and the third block.

Although the support 41 on which the pattern is formed by the phase separation of the BCP layer 43 composed of the block copolymer as described above may be used as it is, the shape of the pattern (polymer nanostructure) on the support 41 may be changed by further heating. The heating temperature is preferably equal to or higher than the glass transition temperature of the block copolymer used and lower than the thermal decomposition temperature. The heating is preferably performed in a gas having low reactivity such as nitrogen.

### Regarding Guide Pattern Forming Step

The method for producing a structure including a phase-separated structure may include a step of providing a guide pattern on the primer layer (a guide pattern forming step) between the above-described step (i) and step (ii). This allows an array structure of the phase-separated structure to be controlled. For example, even if the block copolymer is the one that forms a random fingerprint-shaped phase-separated structure when a guide pattern is not provided, by providing a groove structure of a resist film on the surface of the primer layer, a phase-separated structure oriented along the groove can be obtained. Based on such a principle, a guide pattern may be provided on the primer layer 42. Further, in the case where a surface of a guide pattern has affinity with any one of the blocks constituting the above-mentioned block copolymer, a phase-separated structure having a cylinder structure oriented in a direction perpendicular to the surface of the support is likely to be formed.

The guide pattern can be formed using, for example, a resist composition. For a resist composition for forming a guide pattern, generally, a resist composition having affinity with any of the blocks constituting the block copolymer can be appropriately selected from a composition to be used for forming a resist pattern or a modified product thereof. The resist composition may be either a positive-type resist composition that forms a positive-type pattern, where an exposed area of the resist film is dissolved and removed or a negative-type resist composition that forms a negative-type pattern, where a non-exposed area of a resist film is dissolved and removed, but a negative-type resist composition is preferred. The negative-type resist composition is preferably a resist composition that contains, for example, an acid generating agent and a substrate component having a solubility that decreases in an organic solvent-containing developing solution under action of an acid, and the substrate component contains a resin component having a structural unit that degrades under action of an acid to have an increased polarity. After the BCP composition is poured onto a primer layer on which a guide pattern has been formed, an annealing treatment is performed to cause phase separation. Therefore, as a resist composition capable of forming a guide pattern, a composition capable of forming a resist film having excellent solvent resistance and heat resistance is preferable.

As described above, the present inventor provides the following (1) to (8).
(1) A resin composition for forming a phase-separated structure, including a block copolymer having a first block, a second block, and a third block,
in which the third block is located between the first block and the second block,
the first block is composed of a polymer having a repeating structure of structural unit represented by the following formula (b1),
the second block is composed of a polymer having a repeating structure of structural unit represented by the following formula (b2),
the third block is composed of a polymer having a repeating structure of structural unit derived from a high Log P monomer,
the high Log P monomer has a higher Log P value than methyl methacrylate:

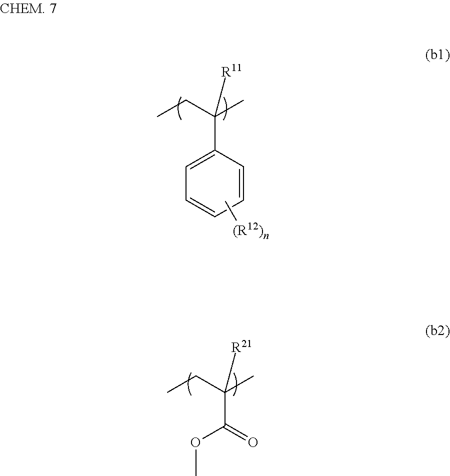

in which in formula (b1), R¹¹ represents a hydrogen atom or a methyl group,
R¹² represents a substituent having 1 to 5 carbon atoms,
n is an integer of 0 or more and 5 or less, and
in formula (b2), R²¹ represents a hydrogen atom or a methyl group.
(2) The resin composition for forming a phase-separated structure as described in (1), in which the Log P value of the monomer is 1.3 or more and 4 or less.
(3) The resin composition for forming a phase-separated structure as described in (1) or (2), in which the third block is composed of a polymer having a repeating structure of structural unit represented by the following formula (b3):

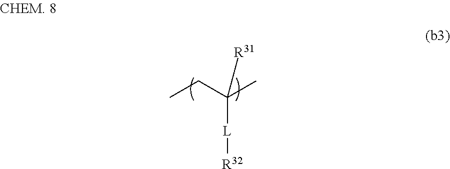

in which in formula (b3), R³¹ represents a hydrogen atom or a methyl group,
L represents a single bond or a divalent linking group, and
R³² represents an organic group having 1 to 15 carbon atoms.
(4) The resin composition for forming a phase-separated structure as described in (3), in which L is a group represented by —C(═O)—O—, the carbonyl group in —C(═O)—O— being bonded to a carbon atom to which R³¹ is bonded,
R³² represents an optionally substituted alkyl group having 2 or more and 15 or less carbon atoms, or a group represented by —R³³—R³⁴,
R³³ is a single bond or a methylene group, R³⁴ being an optionally substituted cycloalkyl group, an optionally substituted aromatic hydrocarbon group, or an optionally substituted heterocyclic group.
(5) The resin composition for forming a phase-separated structure as described in any one of (1) to (4), in which a ratio of the number of moles of the structural unit of the third block to the sum of the number of moles of the structural unit of the first block, the number of moles of the structural unit of the second block, and the number of moles of the structural unit of the third block is 0.1 mol % or more and 10 mol % or less.
(6) The resin composition for forming a phase-separated structure as described in any one of (1) to (5), further containing a homopolymer.
(7) A method for producing a structure having a phase-separated structure, the method comprising:
applying the resin composition for forming a phase-separated structure as described in any one of (1) to (6) on a support to form a layer containing a block copolymer, and
phase separating the layer comprising the block copolymer.
(8) A block copolymer including a first block, a second block, and a third block,
in which the third block is located between the first block and the second block,
the first block is composed of a polymer having a repeating structure of structural unit represented by the following formula (b1),
the second block is composed of a polymer having a repeating structure of structural unit represented by the following formula (b2),
the third block is composed of a polymer having a repeating structure of structural unit derived from a monomer, and
the monomer has a higher Log P value than methyl methacrylate:

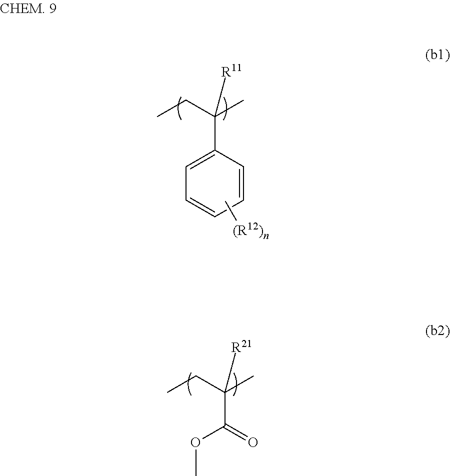

in which in formula (b1), R¹¹ represents a hydrogen atom or a methyl group,
R¹² represents a substituent having 1 to 5 carbon atoms,
n is an integer of 0 or more and 5 or less, and
in formula (b2), R²¹ is a hydrogen atom or a methyl group.

### Examples

Hereinafter, the present invention is described in more detail with reference to Examples.

### (Synthesis of BCP(P-01))

Under an argon atmosphere, 0.1 g (2.36 mmol) of lithium chloride and 169 g of tetrahydrofuran (THF) were placed into a Schlenk tube, and the inside of the tube was cooled to −78° C. After the inside of the tube was dehydrated and degassed, 0.16 mL (1.15 mol/L hexane/cyclohexane mixed solution, 0.19 mmol) of sec-butyllithium (sec-BuLi) as an anionic polymerization initiator was placed into the Schlenk tube under an argon atmosphere, followed by addition of 20.0 mL (174 mmol) of compound (A-1). Thereafter, the contents of the tube were stirred at −78° C. for 30 minutes. After stirring, 0.11 mL (0.58 mmol) of diphenylethylene was placed into the Schlenk tube, and the contents of the tube were stirred at −78° C. for 30 minutes. Further, 0.3 mL (2.6 mmol) of compound (B-1) was placed into the Schlenk tube, and the contents of the tube were stirred at −78° C. for 90 minutes. Then, 9.12 mL (86 mmol) of compound (C-1) was placed into the Schlenk tube, and the contents of the tube were stirred at −78° C. for 90 minutes. After stirring, 2 mL (50 mmol) of methanol (MeOH) as a polymerization terminator was added to the Schlenk tube at −78° C. to terminate the reaction.

The resulting reaction polymerization solution was added dropwise to a large amount of methanol. The precipitated white powder was washed with a large amount of methanol, and then washed with a large amount of pure water. After washing and drying, 24.7 g (yield: 92.1%) of BCP(P-01), a desired block copolymer, was obtained.

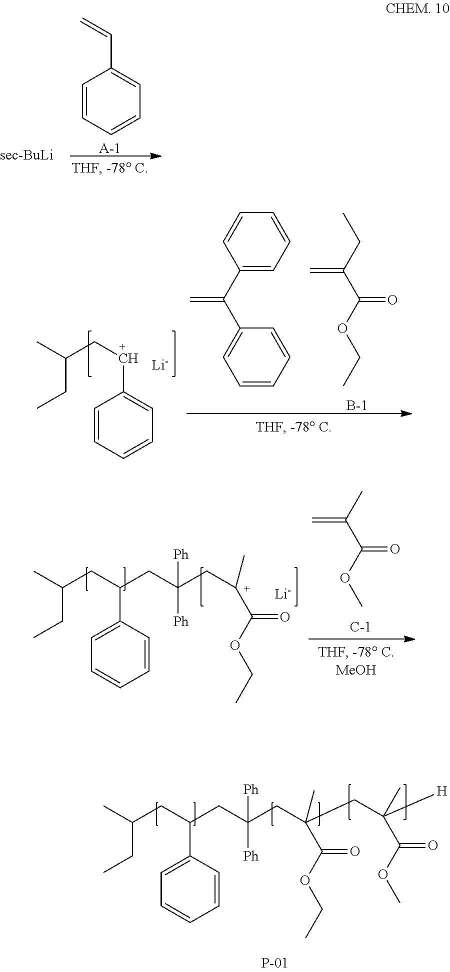

### Synthesis of BCP(P-02) to BCP(P-05)

BCP(P-02) to BCP(P-05) were synthesized in the same manner as in the synthesis of BCP(P-01).

### Synthesis of BCP(P-06) to (P-10)

BCP(P-06) to BCP(P-10) were synthesized in the same manner as in the synthesis of BCP(P-01) except that compounds (B-2) to (B-6) were used in place of compound (B-1):

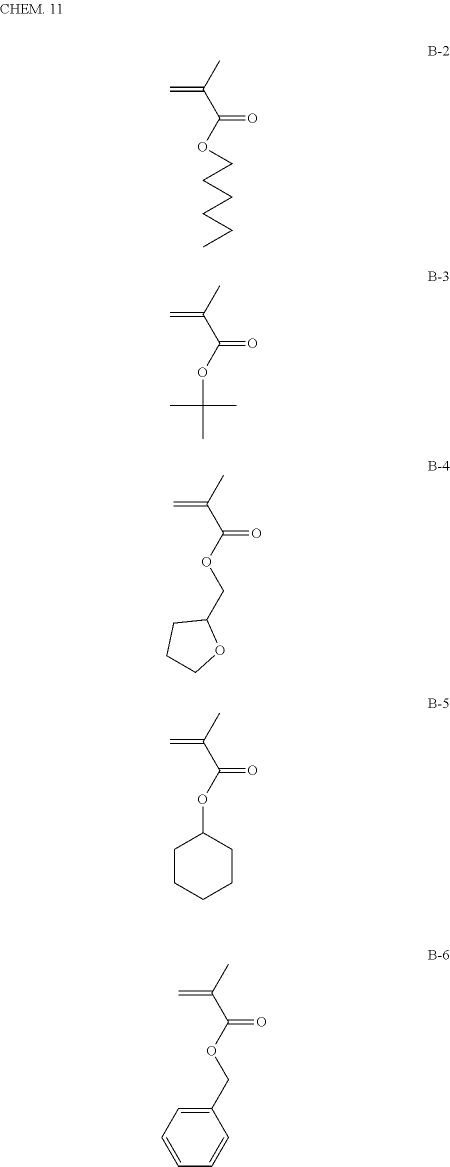

### BCP(p-1)

As BCP(p-1), a block copolymer having a block composed of polystyrene and a block composed of polymethyl methacrylate was used.

### Synthesis of BCP(p-2)

Under an argon atmosphere, 0.1 g (2.36 mmol) of lithium chloride and 169 g of tetrahydrofuran (THF) were placed into a Schlenk tube, and the inside of the tube was cooled to −78° C. After the inside of the tube was dehydrated and degassed, 0.16 mL (1.15 mol/L hexane/cyclohexane mixed solution, 0.19 mmol) of sec-butyllithium (sec-BuLi) as an anionic polymerization initiator was placed into the Schlenk tube under an argon atmosphere, followed by addition of 20.0 mL (174 mmol) of compound (A-1). Thereafter, the contents of the tube were stirred at −78° C. for 30 minutes. After stirring, 0.11 mL (0.58 mmol) of diphenylethylene was placed into the Schlenk tube, and the contents of the tube were stirred at −78° C. for 30 minutes. Further, a monomer mixture of 0.3 mL (2.6 mmol) of compound (B-1) and 9.12 mL (86 mmol) of compound (C-1) were placed into the Schlenk tube, and the contents of the tube were stirred at −78° C. for 90 minutes. After stirring, 2 mL (50 mmol) of methanol as a polymerization terminator was added to the Schlenk tube at −78° C. to terminate the reaction.

The obtained reaction polymerization solution was subjected to the same operation as in the synthesis of BCP(P-01) to obtain BCP(p-2), the desired block copolymer.

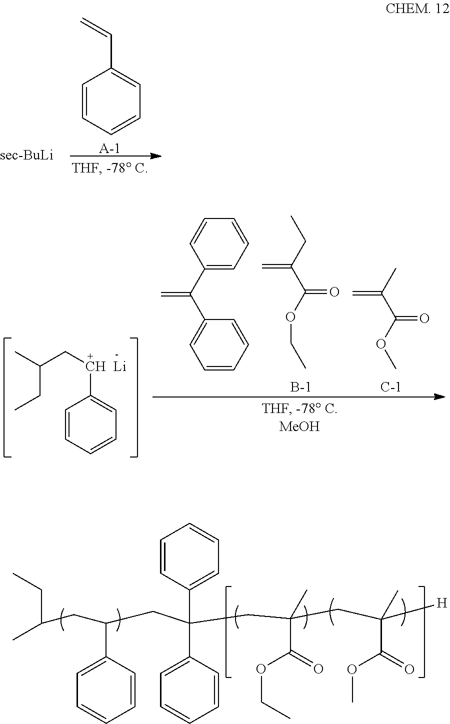

### Synthesis of BCP(p-3)

BCP(p-3) was synthesized in the same manner as in the synthesis of BCP(P-01) except that addition order and reaction order of compound (B-1) and compound (C-1) were transposed.

### Synthesis of BCP(p-4)

BCP(p-4) was synthesized in the same manner as in the synthesis of BCP(P-01) except that compound (b-1) was used in place of compound (B-1):

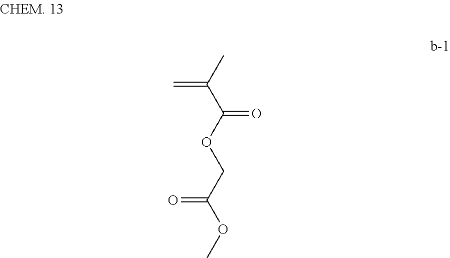

### Measurement of Molar Ratios of Structural Units of Respective Blocks

By ¹³C-NMR measurement (600 MHz, heavy acetone) using an NMR apparatus (manufactured by Bruker, with CryoProbe), an integral ratio value (area ratios) was measured from chemical shifts of the structural units of each block of each block copolymer, and a molar ratio of the structural units of each block was calculated.

A number average molecular weight (Mn) and molecular weight dispersity (PDI) in terms of standard polystyrene of each block copolymer determined by gel permeation chromatography measurement, and a molar ratio of the structural units of each block determined by ¹³C-NMR measurement are shown in Table 1. The Log P values were 1.716 for compound (B-1), 3.754 for compound (B-2), 2.481 for compound (B-3), 1.399 for compound (B-4), 3.179 for compound (B-5), 2.527 for compound (B-6), 0.739 for compound (b-1), 1.207 for compound (C-1), and 2.821 for compound (A-1).

TABLE 1

| | | | | Molar ratios of | | | | |
|---|---|---|---|---|---|---|---|---|
| | Monomer | | | structural units | | | | |
| BCP | First | Third | Second | First | Third | Second | Mn | PDI |
| P-01 | A-1 | B-1 | C-1 | 65 | 1 | 34 | 157,000 | 1.03 |
| P-02 | A-1 | B-1 | C-1 | 65 | 4 | 31 | 159,000 | 1.04 |
| P-03 | A-1 | B-1 | C-1 | 62 | 4 | 34 | 159,000 | 1.03 |
| P-04 | A-1 | B-1 | C-1 | 62 | 7 | 31 | 164,000 | 1.05 |
| P-05 | A-1 | B-1 | C-1 | 58 | 1 | 41 | 157,000 | 1.02 |
| P-06 | A-1 | B-2 | C-1 | 66 | 1 | 33 | 159,000 | 1.02 |
| P-07 | A-1 | B-3 | C-1 | 63 | 2 | 35 | 159,000 | 1.02 |
| P-08 | A-1 | B-4 | C-1 | 64 | 1 | 35 | 158,000 | 1.04 |
| P-09 | A-1 | B-5 | C-1 | 62 | 2 | 36 | 160,000 | 1.04 |
| P-10 | A-1 | B-6 | C-1 | 63 | 1 | 36 | 150,000 | 1.04 |
| p-1 | A-1 | — | C-1 | 65 | — | 35 | 158,000 | 1.03 |
| p-2 | A-1 | B-1/C-1 | | 65 | 1/34 | | 158,000 | 1.02 |
| p-3 | A-1 | C-1 | B-1 | 64 | 34 | 2 | 155,000 | 1.05 |
| p-4 | A-1 | b-1 | C-1 | 65 | 1 | 34 | 162,000 | 1.04 |

### Preparation of Resin Compositions for Forming Phase-Separated Structure

100 parts by mass of a block copolymer (BCP) of the type shown in Table 2, a homopolymer (HP) of the type and amount (parts by mass) shown in Table 2, and an organic solvent component (propylene glycol monomethyl ether acetate) in the amount (parts by mass) shown in Table 2 were mixed and dissolved to prepare a resin composition for forming a phase-separated structure of each Example.

TABLE 2

| | | | | Organic |
|---|---|---|---|---|
| | | HP | HP | solvent |
| | BCP | (PS) | (PMMA) | component |
| Example 1 | P-01 | 79 | 41 | 10,500 |
| Example 2 | P-01 | 53 | 27 | 10,500 |
| Example 3 | P-01 | 26 | 14 | 10,500 |
| Example 4 | P-02 | 79 | 41 | 10,500 |
| Example 5 | P-03 | 75 | 45 | 10,500 |
| Example 6 | P-04 | 75 | 45 | 10,500 |
| Example 7 | P-05 | 24 | 16 | 10,500 |
| Example 8 | P-05 | 40 | 0 | 10,500 |
| Example 9 | P-06 | 67 | 33 | 10,500 |
| Example 10 | P-07 | 67 | 33 | 10,500 |
| Example 11 | P-08 | 65 | 35 | 10,500 |
| Example 12 | P-09 | 63 | 37 | 10,500 |
| Example 13 | P-10 | 64 | 36 | 10,500 |
| Comparative | p-1 | 66 | 34 | 10,500 |
| Example 1 | | | | |
| Comparative | p-2 | 66 | 34 | 10,500 |
| Example 2 | | | | |
| Comparative | p-3 | 65 | 35 | 10,500 |
| Example 3 | | | | |
| Comparative | p-4 | 66 | 34 | 10,500 |
| Example 4 | | | | |

In Table 2, each abbreviation has the following meaning.
P-01 to P-10: BCP(P-01) to (P-10) described above.
p-1 to p-4: BCP(p-1) to (p-4) as described above.
PS: polystyrene (number average molecular weight: 2,000, molecular weight dispersity: 1.03)
PMMA: polymethyl methacrylate (number average molecular weight: 2,000, molecular weight dispersity: 1.03)

### Production of Structure Including Phase Separated Structure (1)

On a 12-inch silicon wafer, a neutralized film composition solution (primer) prepared in a propylene glycol monomethyl ether acetate (PGMEA) solution of about 2.0% by mass was applied using a spinner, and dried by baking and drying at 250° C. for 300 seconds in a nitrogen atmosphere to form a layer (primer layer) composed of a neutralized film having a film thickness of 60 nm on the substrate. Next, a portion of the neutralized film other than the substrate adhesion portion was removed with OK73 thinner (trade name, manufactured by Tokyo Ohka Kogyo), and post-baking was performed at 100° C. for 60 seconds. The resin composition for forming a phase-separated structure of each Example was spin-coated on the layer composed of the neutralized film, and then soft-baked at 90° C. for 60 seconds to form a BCP layer having a film thickness of 66 nm. As the neutralized film composition solution, a PGMEA solution of a random copolymer having styrene (St) units, methyl methacrylate (MMA) units, and 2-hydroxyethyl methacrylate (HEMA) units was used (St/MMA/HEMA=82/12/6 (mol %), number average molecular weight: 45,600, molecular weight dispersity (PDI): 1.76).

The formed BCP layer was annealed under a nitrogen atmosphere to form a phase-separated structure in which a cylinder structure is vertically oriented. The annealing temperature and time were 280° C. and 15 minutes.

The substrate on which the phase-separated structure was formed was irradiated with ultraviolet rays (k: 172 nm) in a nitrogen atmosphere using CLEAN TRACK LITHIUS Pro-Z (manufactured by Tokyo Electron). Thereafter, development was carried out with isopropyl alcohol to selectively remove a phase composed of the second block and the third block, thereby forming a hole pattern.

### L₀ Measurement of Structure

Each of the formed patterns was subjected to image analysis using image analysis software (DSA-APPS, manufactured by Hitachi High-Tech Corporation), and L₀ (nm) in an image of 1,350 nm square was obtained. The results are shown in Table 3.

### Evaluation of Vertical Orientation

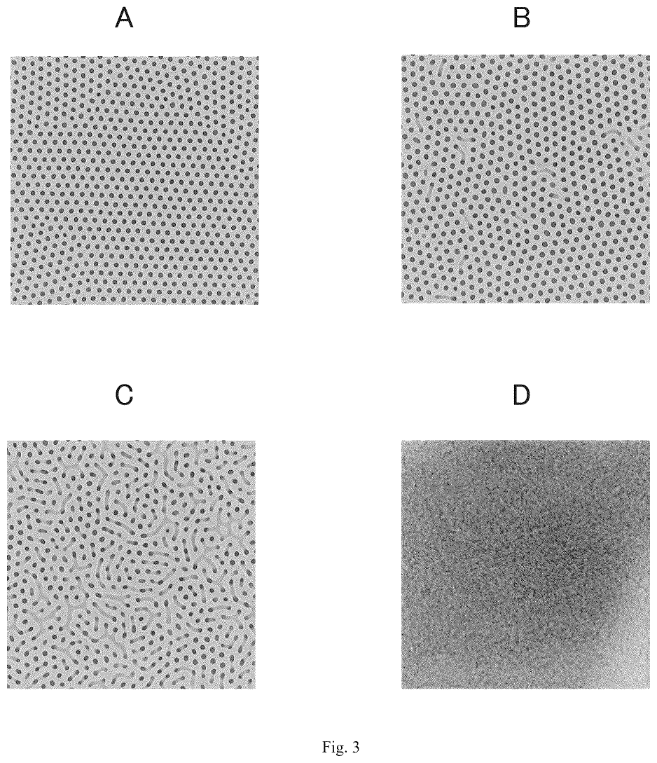

A surface (phase separation state) of the obtained substrate was observed with Critical Dimension SEM (Scanning Electron Microscope, product name: CG6300, manufactured by Hitachi High-Technologies Corporation, acceleration voltage: 800 eV, current value: 15 pA, Frame: 256, magnification: 100 k (image of 1,350 nm square)). As a result of such observation, the phase separation performance was evaluated based on the following evaluation criteria. The results are shown as “vertical orientation” in Table 3. Note that FIG. 3 shows examples of images showing phase separation states corresponding to evaluations A to D.

### Evaluation Criteria

A: in one image, there are 5 or less structures in which a plurality of holes communicate with each other in the horizontal direction.
B: in one image, there are 6 or more and 20 or less structures in which a plurality of holes communicate with each other in the horizontal direction.
C: in one image, there are 21 or more structures in which a plurality of holes communicate with each other in the horizontal direction.
D: vertical orientation and horizontal orientation are largely mixed or there is no orientation.

### Evaluation of Defects

The images of the Examples and the Comparative Examples in which the vertical orientation result was A were subjected to image analysis using image analysis software (DSA-APPS, manufactured by Hitachi High-Tech Corporation), and the number of normal holes (holes surrounded by 6 holes) and the number of defect holes (holes surrounded by 5 or less holes or 7 or more holes) in one image were counted. A defect hole ratio represented by the following formula was determined, and pattern defect was evaluated based on the following evaluation criteria. The results are shown in Table 3 as “defect”.

$$Defect hole ratio ( \% ) = ( number of defect holes / number of normal holes ) \times 100$$

### Evaluation Criteria

A: the ratio is less than 7%.
B: the ratio is 7% or more and less than 10%.
C: the ratio is 10% or more.

### Evaluation of In-Plane Uniformity (CDU/CD)

The images obtained in the evaluation of the vertical orientation were subjected to image analysis using image analysis software (DSA-APPS, manufactured by Hitachi High-Tech Corporation), hole diameters (nm) of 100 holes in the hole pattern were measured, and an average value (CD: nm) was calculated. Then, a value (3σ), which is three times with respect to the standard deviation (a) calculated from the measurement results, was obtained and defined as “CDU (nm)”. The in-plane uniformity index represented by the following formula was obtained, and the in-plane uniformity was evaluated based on the following evaluation criteria. The results are shown in Table 3 as “in-plane uniformity”.

$$In - plane uniformity index ( \% ) = C D U / C D$$

### Evaluation Criteria

A: the index is less than 10%.
B: the index is 10% or more and less than 12%.
C: the index is 12% or more and less than 14%.
D: the index is 14% or more.

### Production of Structure Comprising Phase-Separated Structure (2)

On a 12-inch silicon wafer, a polystyrene film formation composition solution (primer), which was prepared as a propylene glycol monomethyl ether acetate (PGMEA) solution and had a concentration of about 1.0% by mass, was applied using a spinner, and the resulting silicon wafer was dried by baking and drying at 200° C. for 120 seconds in the atmosphere to form a layer (primer layer) composed of a polystyrenated film having a film thickness of 25 nm on the substrate. Next, a portion of the polystyrenated film other than the substrate adhesion portion was removed with an OK73 thinner (trade name, manufactured by Tokyo Ohka Kogyo), and post-baking was performed at 100° C. for 60 seconds. The resin composition for forming a phase-separated structure of each Example was spin-coated on the layer composed of the polystyrene film, and then soft-baked at 90° C. for 60 seconds to form a BCP layer having a film thickness of 66 nm. As the polystyrene film formation composition solution, a PGMEA solution of hydroxy-terminated polystyrene (number average molecular weight: 5,000, molecular weight dispersity (PDI): 1.05) represented by the following formula was used:

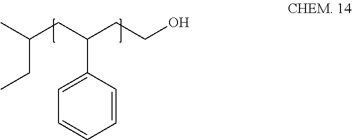

The formed BCP layer was annealed under a nitrogen atmosphere to form a phase-separated structure in which the cylinder structure was horizontally oriented. The annealing temperature and time were 280° C. and 15 minutes.

The substrate on which the phase-separated structure was formed was irradiated with ultraviolet rays (k: 172 nm) in a nitrogen atmosphere using CLEAN TRACK LITHIUS Pro-Z (manufactured by Tokyo Electron). Thereafter, development was performed with isopropyl alcohol to selectively remove the phase composed of the second block and the third block, thereby forming a hole pattern.

### Evaluation of Horizontal Orientation

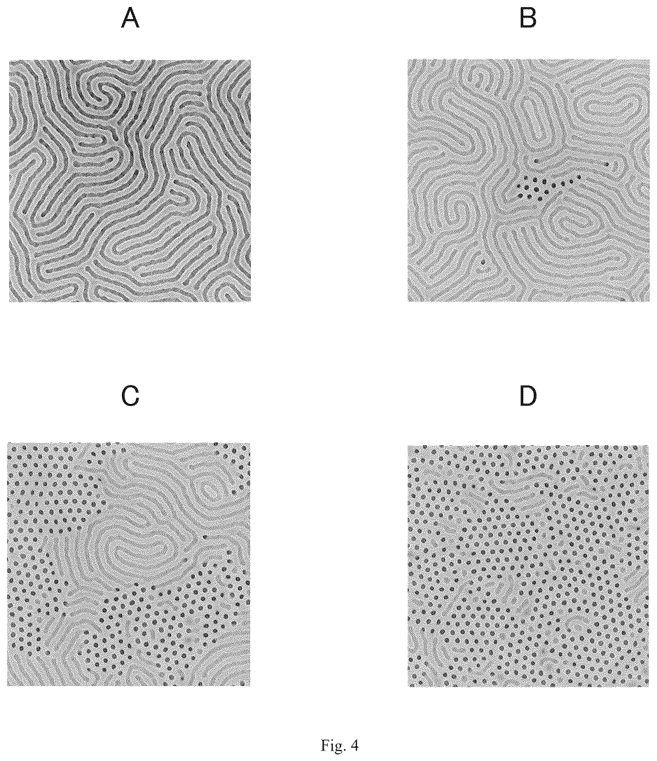

A surface (phase separation state) of the obtained substrate was observed with Critical Dimension SEM (Scanning Electron Microscope, product name: CG6300, manufactured by Hitachi High-Technologies Corporation, acceleration voltage: 800 eV, current value: 15 pA, Frame: 256, magnification: 100 k (image of 1,350 nm square)). As a result of such observation, the phase separation performance was evaluated based on the following evaluation criteria. The results are shown as “horizontal orientation” in Table 3. Note that FIG. 4 shows examples of images showing phase separation states corresponding to evaluations A to D.

### Evaluation Criteria

A: a perfect horizontal orientation is observed.
B: a vertical orientation is partially observed, and a lateral cylinder structure oriented in the horizontal direction is 90% or more.
C: a vertical orientation is partially observed, and a lateral cylinder structure oriented in the horizontal direction is 50% or more and 90% or less.
D: a vertical orientation is partially observed, and a lateral cylinder structure oriented in the horizontal direction is less than 50%.

TABLE 3

| | Vertical | | In-plane | L₀ | Horizontal |
|---|---|---|---|---|---|
| | orientation | Defects | uniformity | (nm) | orientation |
| Example 1 | A | B | B | 50.7 | A |
| Example 2 | A | A | A | 52.5 | A |
| Example 3 | A | A | A | 54.5 | A |
| Example 4 | A | B | A | 50.5 | A |
| Example 5 | A | A | B | 50.4 | A |
| Example 6 | B | — | B | 50.0 | A |
| Example 7 | A | B | B | 50.1 | A |
| Example 8 | A | A | B | 50.2 | A |
| Example 9 | B | — | A | 50.9 | A |
| Example 10 | A | B | A | 51.5 | A |
| Example 11 | A | B | A | 51.4 | B |
| Example 12 | A | C | A | 52.1 | A |
| Example 13 | B | — | B | 50.9 | A |
| Comparative | A | A | A | 53.3 | D |
| Example 1 | | | | | |
| Comparative | A | B | C | 52.4 | A |
| Example 2 | | | | | |
| Comparative | D | — | — | — | C |
| Example 3 | | | | | |
| Comparative | C | — | D | 53.3 | C |
| Example 4 | | | | | |

As shown in Table 3, in Examples 1 to 13 in which predetermined block copolymers were used, all of the horizontal orientation, the vertical orientation, and the in-plane uniformity were excellent. On the other hand, in Comparative Examples 1 to 4 in which other block copolymers were used, at least one of horizontal orientation, vertical orientation, or in-plane uniformity was inferior.

What is claimed is:

1. A resin composition for forming a phase-separated structure, comprising a block copolymer having a first block, a second block, and a third block,
wherein the third block is located between the first block and the second block,
the first block comprises a polymer having a repeating structure of structural unit represented by the following formula (b1),
the second block comprises a polymer having a repeating structure of structural unit represented by the following formula (b2),
the third block comprises a polymer having a repeating structure of structural unit derived from a high Log P monomer,
wherein the high Log P monomer has a higher Log P value than methyl methacrylate: 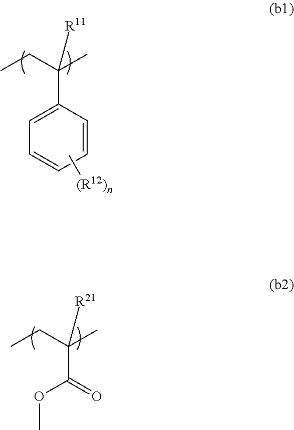
wherein in formula (b1), R¹¹ represents a hydrogen atom or a methyl group,
R¹² represents a substituent having 1 to 5 carbon atoms,
n is an integer of 0 or more and 5 or less, and
in formula (b2), R²¹ represents a hydrogen atom or a methyl group.

2. The resin composition for forming a phase-separated structure according to claim 1, wherein the Log P value of the monomer is 1.3 or more and 4 or less.

3. The resin composition for forming a phase-separated structure according to claim 1, wherein the third block comprises a polymer having a repeating structure of structural unit represented by the following formula (b3): 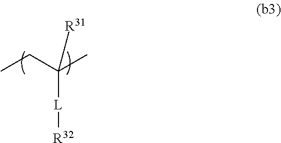
wherein in formula (b3), R³¹ represents a hydrogen atom or a methyl group,
L represents a single bond or a divalent linking group, and
R³² represents an organic group having 1 to 15 carbon atoms.

4. The resin composition for forming a phase-separated structure according to claim 1, wherein L is a group represented by —C(═O)—O—, the carbonyl group in —C(═O)—O— being bonded to a carbon atom to which R³¹ is bonded,
R³² represents an optionally substituted alkyl group having 2 or more and 15 or less carbon atoms, or a group represented by —R³³—R³⁴,
R³³ is a single bond or a methylene group, and
R³⁴ is an optionally substituted cycloalkyl group, an optionally substituted aromatic hydrocarbon group, or an optionally substituted heterocyclic group.

5. The resin composition for forming a phase-separated structure according to claim 1, wherein a ratio of a number of moles of the structural unit of the third block to a sum of a number of moles of the structural unit of the first block, a number of moles of the structural unit of the second block, and the number of moles of the structural unit of the third block is 0.1 mol % or more and 10 mol % or less.

6. The resin composition for forming a phase-separated structure according to claim 1, further comprising a homopolymer.

7. A method for producing a structure having a phase-separated structure, the method comprising:
applying the resin composition for forming a phase-separated structure according to claim 1 on a support to form a layer comprising a block copolymer, and
phase separating the layer comprising the block copolymer.

8. A block copolymer comprising a first block, a second block, and a third block,
wherein the third block is located between the first block and the second block,
the first block comprises a polymer having a repeating structure of structural unit represented by the following formula (b1),
the second block comprises a polymer having a repeating structure of structural unit represented by the following formula (b2),
the third block comprises a polymer having a repeating structure of structural unit derived from a monomer, and
the monomer has a higher Log P value than methyl methacrylate: 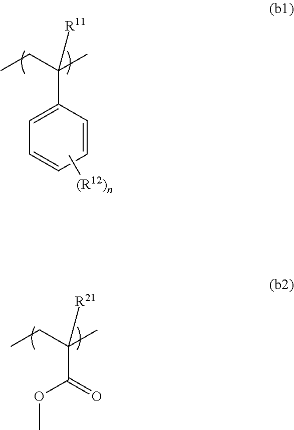
wherein in formula (b1), R¹¹ represents a hydrogen atom or a methyl group,
R¹² represents a substituent having 1 to 5 carbon atoms,
n is an integer of 0 or more and 5 or less, and
in formula (b2), R²¹ is a hydrogen atom or a methyl group.
